(19) United States
(12) Patent Application Publication
(10) Pub. No.: US 2026/0128188 A1
(43) Pub. Date: May 7, 2026

(54) AC-225 PRODUCTION VIA THE RA-226 (N, 2N) REACTION

(71) Applicant: Westinghouse Electric Company LLC, Cranberry Township, PA (US)

(72) Inventors: Eugene T. Hayes, Cranberry Township, PA (US); Michael D. Heibel, Broomfield, CO (US)

(73) Assignee: Westinghouse Electric Company LLC, Cranberry Township, PA (US)

(21) Appl. No.: 18/938,669

(22) Filed: Nov. 6, 2024

(51) Int. Cl. G21G 1/08; G21G 1/00

(52) U.S. Cl. CPC G21G 1/08; G21G 1/001; G21G 2001/0089

(57) ABSTRACT

The present disclosure provides various methods, systems, and devices for producing actinium-225 (Ac-225). In one aspect of the disclosure, a method for producing Ac-225 includes inserting an irradiation target assembly into a commercial nuclear reactor. The irradiation target assembly comprises a radium-226 (Ra-226) material. The method further includes producing electricity using the commercial nuclear reactor by generating a neutron flux in the commercial nuclear reactor. The method further includes irradiating the Ra-226 material with the neutron flux generated in the in the commercial nuclear reactor to produce a radium-225 (Ra-225) material. The Ra-225 material decays to produce an Ac-225 material.

### FIELD

The present disclosure is generally related to methods, systems, and devices for producing actinium-225 and, in several aspects, is directed to methods, systems, and devices for producing actinium-225 via a radium-226 (n, 2n) reaction using a commercial nuclear reactor.

### SUMMARY

According to various aspects, the present disclosure provides a method for producing actinium-225 (Ac-225) using a thermal nuclear reactor. The method includes inserting an irradiation target assembly into a core of the thermal nuclear reactor. The irradiation target assembly includes radium-226 (Ra-226) isotopes. The method further includes generating a neutron flux in the core of the thermal nuclear reactor. The neutron flux comprises thermal neutrons and fast neutrons. The method further includes producing radium-225 (Ra-225) isotopes from a portion of the Ra-226 isotopes via a Ra-226 (n, 2n) reaction based on exposing the irradiation target to the neutron flux. The Ra-225 isotopes decay to produce Ac-225 isotopes.

According to various aspects, the present disclosure provides a method for producing Ac-225 using a commercial nuclear reactor. The method includes inserting an irradiation target assembly into the commercial nuclear reactor. The irradiation target assembly comprises a Ra-226 material. The method further includes producing electricity using the commercial nuclear reactor by generating a neutron flux in the commercial nuclear reactor. The method further includes irradiating the Ra-226 material with the neutron flux generated in the in the commercial nuclear reactor to produce a Ra-225 material. The Ra-225 material decays to produce an Ac-225 material.

According to various aspects, the present disclosure provides a target assembly for irradiating Ra-226 using a nuclear reactor. The target assembly includes at least one target rabbit. Each of the at least one target rabbit can include an outer shell and a target pin insertable into the outer shell. The target pin can encase a Ra-226 material. The target assembly is insertable into the nuclear reactor. In one aspect, the target assembly can include a plurality of the target rabbits coupled together. In another aspect, the target assembly is usable with a Movable Incore Detector System (MIDS) or a Traversing Incore Probe System (TIPS) for insertion into the nuclear reactor.

### BRIEF DESCRIPTION OF THE DRAWINGS

The various aspects described herein, together with objects and advantages thereof, may best be understood by reference to the following description, taken in conjunction with the accompanying drawings as follows.

FIG. 1 is schematic side view of a target assembly for irradiating radium-226 (Ra-226) in a nuclear reactor, according to at least one aspect of the present disclosure.

FIG. 2A is a cross-sectional view of the target assembly of FIG. 1, according to at least one aspect of the present disclosure.

FIG. 2B is a cross-sectional view of another a target assembly for irradiating Ra-226 in a nuclear reactor, according to at least one aspect of the present disclosure.

FIG. 3 is schematic side view of another target assembly for irradiating Ra-226, according to at least one aspect of the present disclosure.

FIG. 4 is a schematic representation of a Movable Incore Detector System (MIDS), according to at least one aspect of the present disclosure.

FIG. 5 illustrates a method for producing Ac-225 using a thermal nuclear reactor, according to at least one aspect of the present disclosure.

Corresponding reference characters indicate corresponding parts throughout the several views. The exemplifications set out herein illustrate various aspects of the present disclosure, in one form, and such exemplifications are not to be construed as limiting the scope of any of the aspects disclosed herein.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus, it can be appreciated that the specific structural and functional details disclosed herein may be representative and illustrative. Variations and changes thereto may be made without departing from the scope of the claims.

Actinium-225 (Ac-225) is an isotope of actinium. Ac-225 is generally considered to be a very valuable material because of its uses related to cancer treatment. For example, the decay properties of Ac-225 can make it suitable for use in Targeted Alpha Therapy (TAT), which is a method of cancer treatment for delivering alpha particles to destroy cancer cells while minimizing damage to surrounding healthy tissue. However, there exists various challenges associated with producing Ac-225. These challenges have caused Ac-225 to be extremely expensive and have limited the available supply of Ac-225 relative to its expected demand for use in cancer treatment.

Although various approaches for producing Ac-225 have been attempted, various challenges related to is production remain. Some of these approaches and associated challenges are described in “Accelerating Production of Non-Carrier Added Actinium-225 (n.c.a. Ac-225),” a NorthStar Medical Radioisotopes white paper published in October 2023, which is incorporated by reference herein.

One approach involves separating thorium-229 (Th-229) from existing stockpiles of uranium-233 (U-233) and collecting small amounts of Ac-225 that result from Th-229 decay. However, due to poor yield and the limited availability of U-233 stockpiles, this approach is expected to support less than 20% of future Ac-225 demand.

Another approach involves producing radium-225 (Ra-225) from Ra-226 via a Ra-226 (p, 2n) reaction using a cyclotron. In this approach, Ra-226 is irradiated with a proton, causing the ejection of two neutrons, and thereby converting Ra-226 to Ra-225. Ra-225 then decays to produce Ac-225.

Another approach involves producing Th-229 from Ra-226 in a nuclear reactor via a Ra-226 (xn, xαβγ) Th-229 reaction or a Th-228 (n, γ) Th-229 reaction. However, this approach can also suffer from challenges, such as poor yield.

Another approach involves the high-energy spallation of Th-232. This approach involves irradiating a Th-232 target with high-energy protons via a large cyclotron or linear accelerator, thereby causing the destruction of the thorium nucleus and the production of Ac-225, along with multiple other isotopes. However, there are a limited number of existing accelerators capable of carrying out this production method. Moreover, this approach can result in the production of unwanted contaminants via side reactions.

Another approach involves photonuclear transmutation of Ra-226 to produce Ra-225 via a Ra-226 (γ, n) reaction. In this approach, an electron accelerator is used to irradiate a Ra-226 target with high-energy photons, thereby ejecting a neutron from Ra-226 and creating Ra-225, which decays to Ac-225.

Yet another approach is described by Iwahashi et al. in “Neutronic Study on Ac-225 Production for Cancer Therapy by (n, 2n) Reaction of Ra-226 or Th-230 Using Fast Reactor Joyo,” Processes 2022, 10(7), 1239 (Iwahashi), which is incorporated by reference herein. The Ra-226 (n, 2n) reaction requires irradiation of Ra-226 with a fast neutron having an energy of at least 6.5 MeV to eject two neutrons and produce Ra-225. Using a Monte Carlo simulation, Iwahashi investigates the potential use of a research-sized, fast nuclear reactor to generate fast neutrons for the Ra-226 (n, 2n) reaction. Iwahashi concludes that a research-sized, fast nuclear reactor would be capable of converting Ra-226 to Ra-225 via the Ra-226 (n, 2n) reaction to produce Ac-225.

However, Iwahashi indicates that it is critical to utilize reactor conditions with a hardened neutron spectrum. For example, Iwahashi (at pages 11 and 12) notes the importance of maximizing the ratio of high-energy neutrons (e.g., energy greater than or equal to 6.5 MeV, fast neutrons) to lower energy (e.g., energy less than 6.5 MeV, thermal neutrons) in the reactor core to maximize Ra-226 (n, 2n) reactions and minimize Ra-226 (n, γ) reactions, thereby minimizing the transmutation of Ra-226 to unwanted contaminants. Therefore, although Iwahashi concludes that research-sized, fast neutron reactors could potentially be used to produce Ra-225 via the Ra-226 (n, 2n) reaction, Iwahashi suggests that other types of reactors, such as commercial thermal nuclear reactors (e.g., boiling water reactors, pressurized water reactors), are not viable options for producing Ra-225 via the Ra-226 (n, 2n) reaction.

Yet another approach is described by International Patent Application Publication No. WO2020254689A1 by De Groot et. al (De Groot), which is incorporated by reference herein. De Groot (at page 2) notes challenges associated with the use of fast neutron reactors to produce Ra-225 via the Ra-226 (n, 2n) reaction (e.g., similar to Iwahashi's approach) and seeks to provide a more-efficient means of producing Ra-225 via the Ra-226 (n, 2n) reaction. Specifically, De Groot's approach involves using a research-sized, high-flux reactor (i.e., the Petten High Flux Reactor) to carry out the Ra-226 (n, 2n) reaction. De Groot explains that the high-flux reactor produces thermal neutron flux and fast neutron flux, and it generally has a lower amount of fast neutron flux in a portion of overall neutron flux compared to fast neutron reactors. De Groot discloses substantially eliminating Ra-226 exposure to the thermal neutron flux by using a thermal neutron absorption shield around the radium-226 target. De Groot states that the thermal neutron absorption shield absorbs the thermal neutrons and allows the fast neutrons to pass therethrough and interact with the radium-226 target (see De Groot at page 3).

However, De Groot teaches away from irradiating the radium-226 target with neutron flux generated by a commercial thermal nuclear reactor. For example, De Groot indicates that, without the use of a thermal neutron absorption shield, thermal neutron activation of radium-226 will increase the generation of unwanted isotopes, thereby increasing the waste stream and the complexity of separating Ra-225 and Ac-225 from the unwanted isotopes (see De Groot at page 3).

Accordingly, in view of various challenges associated with producing Ac-225, there exists a need for alternate methods, systems, and devices for producing Ac-225. The present disclosure provides various methods, systems, and devices for producing Ac-225 via a Ra-226 (n, 2n) reaction using a commercial nuclear reactor.

A method for producing Ac-225 using a commercial nuclear reactor may include inserting an irradiation target assembly (sometimes referred to herein as a target assembly) comprising a Ra-226 material into the commercial nuclear reactor. The Ra-226 material is then irradiated with the neutron flux generated in the commercial nuclear reactor to produce a Ra-225 material, wherein the Ra-225 material decays to produce an Ac-225 material. The target assembly may be removed from the nuclear reactor to obtain the Ra-225 material and/or Ac-225 material.

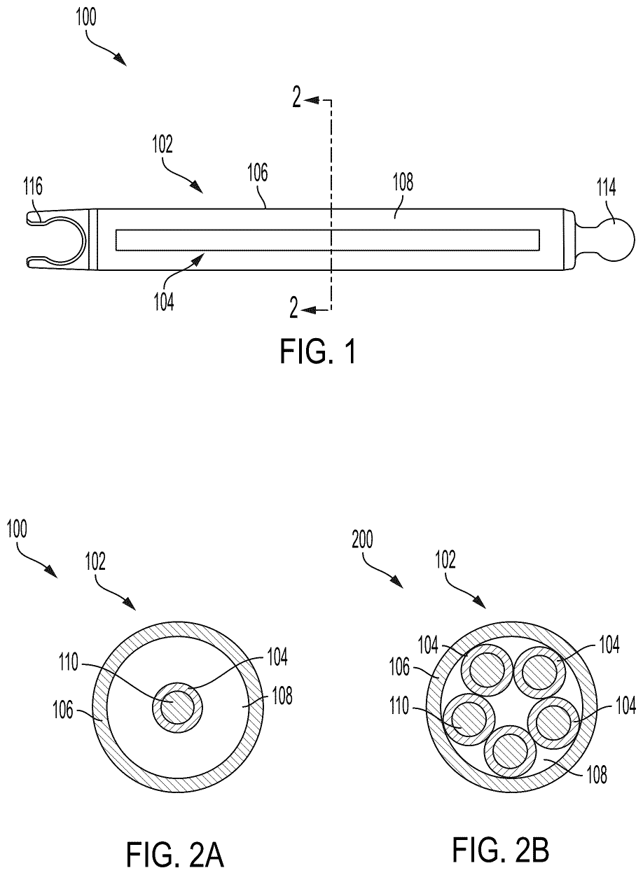

The Ra-226 material may comprise Ra-226 isotopes. For example, the Ra-226 material can be a Ra-226 salt comprising Ra-226 isotopes. The target assembly may be configured to house the Ra-226 salt. The target assembly may be similar to the various target assemblies described herein, such as, for example, any of the target assemblies disclosed with respect to FIGS. 1-3.

The neutron flux generated in the commercial nuclear reactor can comprise thermal neutrons and fast neutrons. In some examples, the ratio of thermal neutrons to fast neutrons in the neutron flux in the commercial nuclear reactor (e.g., at a core center of the nuclear reactor) may be greater than 10:1, such as, for example, greater than 100:1, greater than 1,000 to 1, or greater than 10,000 to 1. At least a portion of the fast neutrons in the neutron flux generated in the commercial nuclear reactor have an energy of greater than or equal to 6.5 MeV.

Irradiating the Ra-226 material with the neutron flux generated in the commercial nuclear reactor to produce the Ra-225 material may include irradiating the Ra-226 material with thermal neutrons and fast neutrons. The fast neutrons having an energy of greater than or equal to 6.5 MeV can cause transmutation of at least a portion of the Ra-226 isotopes in the Ra-226 material, via a Ra-226 (n, 2n) reaction, to produce the Ra-225 material.

The commercial nuclear reactor may be capable of producing electricity by generating the neutron flux. For example, the commercial nuclear reactor may be a pressurized water reactor (PWR) or a boiling water reactor (BWR). The commercial nuclear reactor may be sized or otherwise configured to produce at least 100 mW of electrical power, such as, for example, at least 200 mW, at least 500 mW, at least 750 mW, or at least 1,000 mW of electrical power. In various examples, the Ra-226 material may be irradiated with the neutron flux generated in the in the commercial nuclear reactor to produce a Ra-225 material while the nuclear reactor is producing electricity with the neutron flux.

The use of a commercial nuclear reactor capable of producing electricity, sized as described above, can enable relatively large amounts of the Ra-226 material to be inserted therein (e.g., because of its larger size). In some embodiments, the target assembly can house or otherwise comprise at least 500 mg of the Ra-226 material, such as, for example, at least 11 g, at least 2 g, at least 3 g, at least 5 g, at least 10 g, at least 40 g, at least 50 g, or at least 100 g of the Ra-226 material. Thus, compared to using a smaller research-sized fast reactor or research-sized high-flux reactor, which generally does not have space available to receive a target assembly (or target assemblies) capable of housing multiple grams of Ra-226 material, using a commercial nuclear reactor can enable much larger amounts of the Ra-226 material to be processed and can therefore enable the production of larger amounts of the Ra-225 material.

The commercial nuclear reactor may be in continuous operation (e.g. 24 hours a day, 7 days a week) for long periods of time (e.g., for at least one year) to produce electricity. During the continuous operation of the commercial nuclear reactor, the irradiation target assembly may be repeatedly inserted into and retracted from the core of the commercial nuclear reactor to produce the Ac-225 material from the Ra-226 material, wherein the irradiation target assembly is replenished with new Ra-226 material for each repetition. Moreover, in some examples, more than one irradiation target assembly (e.g., 2, 3, 4, or 5 target assemblies) may be concurrently inserted into a core of the commercial reactor during each repetition to produce the Ac-225 material from the Ra-226 material. Accordingly, compared to smaller research-sized reactors (e.g. fast reactors) that operate intermittently and infrequently, and only have limited capacity to receive target material, a commercial nuclear reactor can operate continuously, for much longer periods of time, and has a much larger capacity to produce Ac-225 material from Ra-226 material.

Using the relatively larger amounts the Ra-226 material, as described above, can enable the production of the Ra-225 material using neutron flux that comprises a high ratio of thermal neutrons to fast neutrons (e.g., greater than 1,000 to 1, such as, greater than 10,000 to 1, greater than 100,000 to 1, or greater than 1,000,000 to 1). For example, transmuting only a portion (e.g., less than 5%, less than 4%, less than 3%, or less than 2%) of the Ra-226 isotopes in the Ra-226 material with fast neutrons via the Ra-226 (n, 2n) reaction can nevertheless result in the production of a larger amount of the Ra-225 material (and thus Ac-225 material) compared to other approaches. Furthermore, using the relatively larger amounts of the Ra-226 material can enable the Ra-226 material to be irradiated with thermal neutrons and fast neutrons and therefore can avoid the need to use a thermal neutron absorption shield.

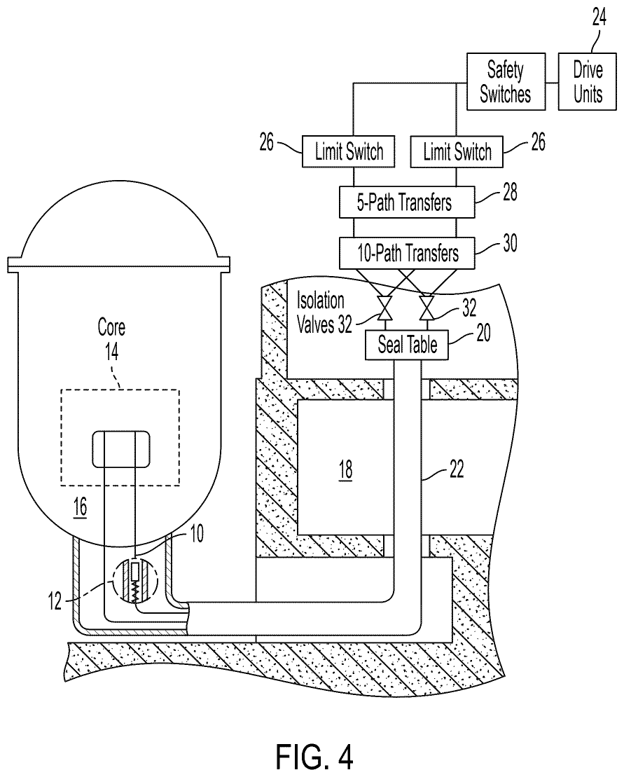

The target assembly may be inserted into the core of the commercial nuclear reactor using a Movable Incore Detector System (MIDS) (e.g., of a PWR) or a Traversing Incore Probe System (TIPS) (e.g., of a BWR). Thus, according to various aspects, existing commercial nuclear reactors can be employed to produce Ac-225 with minimal retrofitting. Various systems and methods of inserting the target assembly into the core of the commercial nuclear reactor are described further herein with respect to FIG. 4.

FIG. 1 is schematic side view of a target assembly 100, and FIG. 2A is a cross-sectional view of the target assembly 100 of FIG. 1 taken along the line 2-2. The target assembly 100 can be used to insert a Ra-226 material into the core of a commercial nuclear reactor, for example, using a MIDS or a TIPS.

Referencing FIGS. 1 and 2A, the target assembly 100 includes a target rabbit 102. The target rabbit 102 includes an outer shell 106 and a target pin 104 that is insertable into and removable from the outer shell 106. The target rabbit 102 can define an open space 108 between the outer shell 106 and the target pin 104.

As shown in FIG. 2A, the target pin 104 can encase an Ra-226 material 110 (e.g., an Ra-226 salt). To process the Ra-226 material 110, the Ra-226 material may be loaded into and secured within the target pin 104. The target pin 104 can then be positioned within the target rabbit 102, and the target rabbit 102/target assembly 100 can be inserted into the core of a commercial nuclear reactor. After irradiating the target assembly 100 to cause transmutation of at least a portion of the Ra-226 material 110 to a Ra-225 material, the target assembly 100 can be withdrawn from the core of the reactor, the target pin 104 can be removed from the target rabbit 102, and the Ra-225 material (and Ac-225 material) can be collected from the target pin 104.

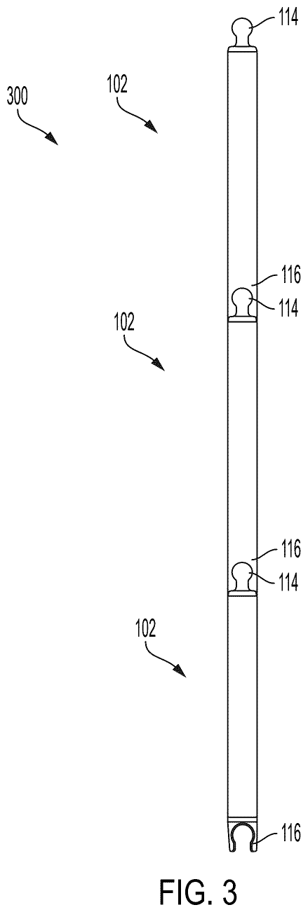

As illustrated by the example embodiment of FIG. 1, the target assembly 100 includes one target rabbit 102. However, other embodiments of the target assembly can include a plurality of target rabbits 102 (e.g., similar to the target assembly 300 of FIG. 3).

The outer shell 106 of the target rabbit 102 can comprise an outer diameter that is sized to be insertable into the fission chamber of a nuclear reactor via conduit of a MIDS or a TIPS.

The target rabbit 102 may include a first coupling 114 and/or a second coupling 116. The first coupling 114 is at a first end of the target rabbit 102, and the second coupling 116 is at a second end of the target rabbit 102 opposite the first end.

In various aspects, the first coupling 114 and/or the second coupling 116 may be configured to couple the target assembly 100 to a retractable cable of a MIDS or a TIPS.

In various aspects, referring now FIG. 3, the first coupling 114 and/or the second coupling 116 may be configured to couple the target rabbit 102 to another target rabbit 102. For example, FIG. 3 illustrates a target assembly 300 including three target rabbits 102 coupled together using, respectively, the first couplings 114 and the second couplings 116. Although the embodiment of the target assembly 300 illustrated by FIG. 3 includes three target rabbits 102, any number of target rabbits 102 can be linked together to form a target assembly, for example, to achieve increased capacity for processing the Ra-226 material 110.

As shown in the example target assemblies 100 and 300 illustrated by FIGS. 1 and 3, the first coupling 114 and the second coupling 116 can define a ball and socket, respectively, of a ball and socket joint, thereby enabling the target assembly to be coupled with another target assembly. Thus, the first coupling 114 and the second coupling 116 can be used to form a flexible chain of target rabbits 102, pivotable at the couplings 114, 116. This can enable the target assembly 300 to navigate bends of a conduit as it is inserted into or retracted from a MIDS or a TIPS.

The outer shell 106 of the target rabbit 102 and/or the target pin 104 can be constructed of a materials suitable for insertion into a core of a commercial nuclear reactor (e.g., via a MIDS or a TIPS). For example, the outer shell 106 of the target rabbit 102 and/or the target pin 104 can be constructed of aluminum, vanadium, or stainless steel.

In various aspects, as illustrated in the embodiment of FIG. 2A, the target rabbit 102 can comprise one target pin 104. In other aspects, as illustrated by the embodiment of the target assembly 200 in FIG. 2B, the target rabbit 102 can include a plurality of target pins 104, wherein each target pin 104 encases the Ra-226 material 110. Although the embodiment of the target assembly 200 illustrated by FIG. 2B illustrates a target rabbit 102 including five target pins 104, other numbers of target pins 104 (e.g., two, three, four, six, seven, eight) may be included in the target rabbit 102. The outer shell 106 of the target rabbit 102 may be sized to accommodate the target pins 104. Including a plurality of target pins 104 in the target rabbit 102 can achieve increased capacity for processing the Ra-226 material 110.

FIG. 4 is a schematic representation of a system for the insertion of the movable detectors 12 into a reactor core 14 (e.g., a MIDS), according to one aspect of the present disclosure. Retractable thimbles 10, into which the moveable detectors 12 are driven, can be routed as shown in FIG. 4. The retractable thimbles 10 are inserted into the reactor core 14 through conduits 22 extending from the bottom of the reactor vessel 16 through a concrete shield area 18 and then up to a thimble seal table 20. Mechanical seals between the retractable thimbles 10 and the conduits 22 are provided at the thimble seal table 20. The conduits 22 can serve as extensions of the reactor vessel 16, with the retractable thimbles 10 allowing the insertion of the in-core instrumentation movable detectors 12. During operation, the retractable thimbles 10 may be stationary and may be retracted under depressurized conditions during refueling or maintenance operations. Withdrawal of a thimble to the bottom of the reactor vessel is also possible if work is required on the vessel internals.

The drive system for insertion of the moveable detectors 12 can include drive units 24, limit switch assemblies 26, 5-path rotary transfer devices 28, 10-path rotary transfer devices 30, and isolation valves 32. Each drive unit pushes a hollow helical-wrap drive cable into the core with a moveable detector 12 attached to the leading end of the cable and a small diameter coaxial cable, which communicates the detector output, threaded through the hollow center back to the trailing end of the drive cable.

Rather than attaching the moveable detector 12, a target assembly (e.g., target assembly 100, 200, 300) may be coupled to one or more than one of the retractable thimbles 10. The retractable thimble(s) 10 can be used in the insertion and retraction of the target assembly for the irradiation of a Ra-226 material, as described herein. Thus, according to various aspects, existing nuclear reactors with a MIDS system can be employed to produce Ac-225, using the target assemblies described herein, with minimal retrofitting. A similar approach can be employed using a TIPS of a nuclear reactor.

Various aspects of a MIDS and use of a MIDS for transmutation of a desired target isotope described herein are similar to those described by U.S. Pat. No. 10,755,829 (the '829 patent), which is herein incorporated by reference it its entirety. Any aspects of the '829 patent, such as the isotope production cable assembly, driver cable assembly, and target holder element, may be employed for processing a Ra-226 material, as described further herein. The devices, systems, and methods for moving a target material into and withdrawing the target material from a nuclear reactor discussed above and in the '829 patent are applicable to the present disclosure to move a target assembly into a nuclear reactor and withdraw the target assembly from the nuclear reactor.

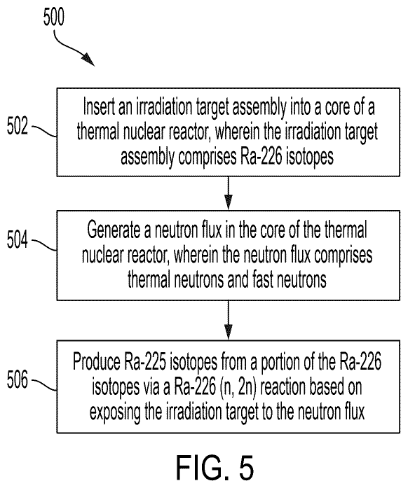

FIG. 5 illustrates a method 500 for producing Ac-225 material using a thermal nuclear reactor, according to one aspect of the present disclosure. According to the method 500, an irradiation target assembly is inserted 502 into a core of the thermal nuclear reactor. The irradiation target assembly comprises Ra-226 isotopes. A neutron flux is generated 504 in the core of the thermal nuclear reactor. The neutron flux comprises thermal neutrons and fast neutrons. Ra-225 isotopes are produced 506 from a portion of the Ra-226 isotopes via a Ra-226 (n, 2n) reaction based on exposing the irradiation target to the neutron flux. The Ra-225 isotopes decay to produce Ac-225 isotopes.

According to various aspects of the method 500, the thermal nuclear reactor is a commercial pressurized water reactor (PRW) or a commercial boiling water reactor (BWR). Inserting 502 the irradiation target assembly into the core of the thermal nuclear reactor can include inserting the irradiation target assembly via a Movable Incore Detector System (MIDS) or a Traversing Incore Probe System (TIPS).

According to various aspects of the method 500, the irradiation target assembly comprises a target rabbit couplable to a MIDS or a TIPS and a target pin housed within the target rabbit. The target pin encases the Ra-226 isotopes. The target rabbit can include a shell to house the target pin, and the target rabbit can define a gap between the shell and the target pin. In one aspect, the irradiation target assembly comprises a plurality of the target pins housed within the target rabbit.

According to various aspects of the method 500, the irradiation target assembly comprises a plurality of the irradiation target rabbits coupled together. In one aspect, the target rabbits are coupled together via ball-and-socket joints to form a flexible chain of target rabbits.

According to various aspects of the method 500, producing 506 the Ra-225 isotopes from a portion of the Ra-226 isotopes via the Ra-226 (n, 2n) reaction based on exposing the irradiation target assembly to the neutron flux comprises exposing the Ra-226 isotopes to the thermal neutrons and the fast neutrons.

According to various aspects of the method 500, the irradiation target assembly does not comprise a thermal neutron shield configured to block the thermal neutrons from being exposed to the Ra-226 isotopes.

According to various aspects of the method 500, a ratio of the thermal neutrons to the fast neutrons in the neutron flux exposed to the irradiation target assembly is greater than 1,000 to 1.

According to various aspects of the method 500, the irradiation target assembly comprises a Ra-226 salt material comprising the Ra-226 isotopes. In one aspect, the irradiation target assembly comprises greater than 1,000 mg of the Ra-226 salt.

According to various aspects of the method 500, the thermal nuclear reactor is a commercial reactor configured to generate at least 100 mW of electrical power.

Various examples of the devices, systems, and methods described herein are set out in the following clauses.

Clause 1. A method for producing Ac-225 using a thermal nuclear reactor, the method comprising: inserting an irradiation target assembly into a core of the thermal nuclear reactor, wherein the irradiation target assembly comprises Ra-226 isotopes; generating a neutron flux in the core of the thermal nuclear reactor to produce electrical power, wherein the neutron flux comprises thermal neutrons and fast neutrons; and producing Ra-225 isotopes from a portion of the Ra-226 isotopes via a Ra-226 (n, 2n) reaction based on exposing the irradiation target to the neutron flux, wherein the Ra-225 isotopes decay to produce Ac-225 isotopes.

Clause 2. The method of Clause 1, wherein the thermal nuclear reactor is a commercial reactor configured to produce at least 100 mW of the electrical power, and wherein generating the neutron flux in the core of the thermal nuclear reactor to produce the electrical power comprises operating the commercial reactor continuously for at least a year, the method further comprising repeatedly during the at least one year of operating the commercial reactor inserting the irradiation target assembly into the core of the thermal nuclear reactor, each time replenished with new Ra-226 isotopes, and producing the Ra-225 isotopes from a portion of the new Ra-226 isotopes.

Clause 3. The method of Clause 2, wherein, for each time the irradiation target assembly is inserted into the core of the thermal nuclear reactor, the irradiation target assembly comprises greater than 1g of a Ra-226 salt material comprising the Ra-226 isotopes.

Clause 4. The method of any of Clauses 1-3, wherein producing the Ra-225 isotopes from a portion of the Ra-226 isotopes via the Ra-226 (n, 2n) reaction based on exposing the irradiation target assembly to the neutron flux comprises exposing the Ra-226 isotopes to the thermal neutrons and the fast neutrons.

Clause 5. The method of any of Clauses 1-4, wherein the irradiation target assembly does not comprise a thermal neutron jacket configured to block the thermal neutrons from being exposed to the Ra-226 isotopes.

Clause 6. The method of any of Clauses 1-5, wherein a ratio of the thermal neutrons to the fast neutrons in the neutron flux exposed to the irradiation target assembly is greater than 10 to 1.

Clause 7. The method of any of Clauses 1-6, wherein the thermal nuclear reactor is a commercial pressurized water reactor (PRW) or a commercial boiling water reactor (BWR), and wherein inserting the irradiation target assembly into the core of the thermal nuclear reactor comprises inserting the irradiation target assembly via a movable incore detector system (MIDS) or a traversing incore probe system (TIPS).

Clause 8. The method of any of Clauses 1-7, wherein the irradiation target assembly comprises: a target rabbit couplable to the MIDS or the TIPS; and a target pin housed within the target rabbit, wherein the target pin encases the Ra-226 isotopes.

Clause 9. The method of Clause 8, wherein the target rabbit comprises a shell to house the target pin, and wherein the target rabbit defines a gap between the shell and the target pin.

Clause 10. The method of Clause 9, the irradiation target assembly comprises a plurality of the target pins housed within the target rabbit.

Clause 11. The method of any of Clauses 8-9, wherein the irradiation target assembly comprises a plurality of the irradiation target rabbits coupled together.

Clause 12. The method of Clause 11, wherein the target rabbits are coupled together via one or more than one ball-and-socket joint to form a chain of target rabbits.

Clause 13. A method for producing Ac-225 using a commercial nuclear reactor, the method comprising: inserting an irradiation target assembly into the commercial nuclear reactor, wherein the irradiation target assembly comprises a Ra-226 material; producing electricity using the commercial nuclear reactor by generating a neutron flux in the commercial nuclear reactor; and irradiating the Ra-226 material with the neutron flux generated in the commercial nuclear reactor to produce a Ra-225 material, wherein the Ra-225 material decays to produce an Ac-225 material.

Clause 14. The method of Clause 13, wherein producing the electricity using the commercial nuclear reactor comprises producing at least 100 mW of electrical power.

Clause 15. The method of any of Clauses 12-14, wherein the irradiation target assembly comprises at least 1 g of the Ra-226 material.

Clause 16. The method of any of Clauses 12-15, wherein irradiating the Ra-226 material with the neutron flux generated in the commercial nuclear reactor comprises irradiating the Ra-226 material with thermal neutrons and fast neutrons, and wherein a ratio of thermal neutrons to fast neutrons in the neutron flux is greater than 10:1.

Clause 17. The method of any of Clauses 12-16, wherein the Ra-225 material is produced via a Ra-226 (n, 2n) reaction.

Clause 18. The method of any of Clauses 12-17, further comprising repeatedly inserting the irradiation target assembly into a core of the commercial nuclear reactor and retracting the target assembly from the core of the commercial reactor to produce and collect the Ac-225 material while continuously producing electricity using the commercial nuclear reactor for at least one year.

Clause 19. The method of any of Clauses 12-18, wherein inserting the irradiation target assembly into the commercial nuclear reactor comprises inserting the irradiation target assembly into the commercial nuclear reactor via a movable incore detector system (MIDS) or a traversing incore probe system (TIPS).

Clause 20. The method of any of Clauses 12-19, further comprising concurrently inserting a plurality of the irradiation target assemblies into the commercial nuclear reactor.

Those skilled in the art will recognize that, in general, terms used herein, and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to”). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general, such a construction is intended in the sense one having skill in the art would understand the convention (e.g., “a system having at least one of A, B, and C” would include, but not be limited to, systems that have A alone, B alone, C alone, A and B together, A and C together, B and C together, and/or A, B, and C together). In those instances where a convention analogous to “at least one of A, B, or C, etc.” is used, in general, such a construction is intended in the sense one having skill in the art would understand the convention (e.g., “a system having at least one of A, B, or C” would include, but not be limited to, systems that have A alone, B alone, C alone, A and B together, A and C together, B and C together, and/or A, B, and C together). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures, or characteristics may be combined in any suitable manner in one or more aspects.

Any patent application, patent, non-patent publication, or other disclosure material referred to in this specification and/or listed in any Application Data Sheet is incorporated by reference herein to the extent that the incorporated materials are not inconsistent herewith. As such, and to the extent necessary, the disclosure as explicitly set forth herein supersedes any conflicting material incorporated herein by reference. Any material, or portion thereof, that is said to be incorporated by reference herein but that conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a system that “comprises,” “has,” “includes,” or “contains” one or more elements possesses those one or more elements but is not limited to possessing only those one or more elements. Likewise, an element of a system, device, or apparatus that “comprises,” “has,” “includes,” or “contains” one or more features possesses those one or more features but is not limited to possessing only those one or more features.

The term “substantially,” “about,” or “approximately” as used in the present disclosure, unless otherwise specified, means an acceptable error for a particular value as determined by one of ordinary skill in the art, which depends in part on how the value is measured or determined. In certain embodiments, the term “substantially,” “about,” or “approximately” means within one, two, three, or four standard deviations. In certain embodiments, the term “substantially,” “about,” or “approximately” means within 50%, 20%, 15%, 10%, 9%, 8%, 7%, 6%, 5%, 4%, 3%, 2%, 1%, 0.5%, or 0.05% of a given value or range.

In summary, numerous benefits have been described that result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A method for producing Ac-225 using a thermal nuclear reactor, the method comprising:
inserting an irradiation target assembly into a core of the thermal nuclear reactor, wherein the irradiation target assembly comprises Ra-226 isotopes;
generating a neutron flux in the core of the thermal nuclear reactor to produce electrical power, wherein the neutron flux comprises thermal neutrons and fast neutrons; and
producing Ra-225 isotopes from a portion of the Ra-226 isotopes via a Ra-226 (n, 2n) reaction based on exposing the irradiation target to the neutron flux, wherein the Ra-225 isotopes decay to produce Ac-225 isotopes.

2. The method of claim 1, wherein the thermal nuclear reactor is a commercial reactor configured to produce at least 100 mW of the electrical power, and wherein generating the neutron flux in the core of the thermal nuclear reactor to produce the electrical power comprises operating the commercial reactor continuously for at least a year, the method further comprising repeatedly during the at least one year of operating the commercial reactor inserting the irradiation target assembly into the core of the thermal nuclear reactor, each time replenished with new Ra-226 isotopes, and producing the Ra-225 isotopes from a portion of the new Ra-226 isotopes.

3. The method of claim 2, wherein, for each time the irradiation target assembly is inserted into the core of the thermal nuclear reactor, the irradiation target assembly comprises greater than 1g of a Ra-226 salt material comprising the Ra-226 isotopes.

4. The method of claim 3, wherein producing the Ra-225 isotopes from a portion of the Ra-226 isotopes via the Ra-226 (n, 2n) reaction based on exposing the irradiation target assembly to the neutron flux comprises exposing the Ra-226 isotopes to the thermal neutrons and the fast neutrons.

5. The method of claim 4, wherein the irradiation target assembly does not comprise a thermal neutron jacket configured to block the thermal neutrons from being exposed to the Ra-226 isotopes.

6. The method of claim 4, wherein a ratio of the thermal neutrons to the fast neutrons in the neutron flux exposed to the irradiation target assembly is greater than 10 to 1.

7. The method of claim 4, wherein the thermal nuclear reactor is a commercial pressurized water reactor (PRW) or a commercial boiling water reactor (BWR), and wherein inserting the irradiation target assembly into the core of the thermal nuclear reactor comprises inserting the irradiation target assembly via a movable incore detector system (MIDS) or a traversing incore probe system (TIPS).

8. The method of claim 7, wherein the irradiation target assembly comprises:
a target rabbit couplable to the MIDS or the TIPS; and
a target pin housed within the target rabbit, wherein the target pin encases the Ra-226 isotopes.

9. The method of claim 8, wherein the target rabbit comprises a shell to house the target pin, and wherein the target rabbit defines a gap between the shell and the target pin.

10. The method of claim 9, the irradiation target assembly comprises a plurality of the target pins housed within the target rabbit.

11. The method of claim 9, wherein the irradiation target assembly comprises a plurality of the irradiation target rabbits coupled together.

12. The method of claim 11, wherein the target rabbits are coupled together via one or more than one ball-and-socket joint to form a chain of target rabbits.

13. A method for producing Ac-225 using a commercial nuclear reactor, the method comprising:
inserting an irradiation target assembly into the commercial nuclear reactor, wherein the irradiation target assembly comprises a Ra-226 material;
producing electricity using the commercial nuclear reactor by generating a neutron flux in the commercial nuclear reactor; and
irradiating the Ra-226 material with the neutron flux generated in the commercial nuclear reactor to produce a Ra-225 material, wherein the Ra-225 material decays to produce an Ac-225 material.

14. The method of claim 13, wherein producing the electricity using the commercial nuclear reactor comprises producing at least 100 mW of electrical power.

15. The method of claim 14, wherein the irradiation target assembly comprises at least 1 g of the Ra-226 material.

16. The method of claim 15, wherein irradiating the Ra-226 material with the neutron flux generated in the commercial nuclear reactor comprises irradiating the Ra-226 material with thermal neutrons and fast neutrons, and wherein a ratio of thermal neutrons to fast neutrons in the neutron flux is greater than 10:1.

17. The method of claim 16, wherein the Ra-225 material is produced via a Ra-226 (n, 2n) reaction.

18. The method of claim 17, further comprising repeatedly inserting the irradiation target assembly into a core of the commercial nuclear reactor and retracting the target assembly from the core of the commercial reactor to produce and collect the Ac-225 material while continuously producing electricity using the commercial nuclear reactor for at least one year.

19. The method of claim 18, wherein inserting the irradiation target assembly into the commercial nuclear reactor comprises inserting the irradiation target assembly into the commercial nuclear reactor via a movable incore detector system (MIDS) or a traversing incore probe system (TIPS).

20. The method of claim 19, further comprising concurrently inserting a plurality of the irradiation target assemblies into the commercial nuclear reactor.
